(19) United States
(12) Patent Application Publication
(10) Pub. No.: US 2002/0102044 A1
(43) Pub. Date: Aug. 1, 2002

(54) Optical circuit device

(75) Inventors: Joseph Alan Barnard, London (GB); Lee Smethurst, Abingdon (GB)

Correspondence Address: FULBRIGHT & JAWORSKI, LLP, 1301 MCKINNEY, SUITE 5100, HOUSTON, TX, 77010-3095, US

(73) Assignee: Bookham Technologies PLC, Abingdon (GB)

(21) Appl. No.: 10/041,915

(22) Filed: Jan. 8, 2002

(30) Foreign Application Priority Data
Jan. 8, 2001 (GB) 0100422.5

(51) Int. Cl. G02B 6/12

(52) U.S. Cl. 385/14

(57) ABSTRACT

An optical circuit device (1; 1′) has a substrate (6; 5′) with a surface (7; 7′) and a structural discontinuity (17; 17′) in the surface. The surface is provided with a light source (13: 13′) to emit light and a circuit element (15; 15′) whose performance is adversely affected by the incidence thereon of stray light emifted by the light source. To reduce optical cross-talk, the optical circuit device is provided with a barrier element (21; 21′) which is adapted to absorb light emitted by the light source. The barrier element is located in the structural discontinuity and is so positioned as to be able to absorb stray light embted by the light source The optical circuit device may be an optical transceiver having a laser diode and a photodiods.

### BACKGROUND OF THE INVENTION

An example of an optical circuit device is an optical transceiver. An optical transceiver typically comprises a substrate of silicon mounted on an insulator (silicon-on-insulator chip), a laser diode and a photodiode located on an upper surface of the silicon substrate, and optical waveguides formed on the upper surface for respectively transmitting light from, and to, the laser diode and the photodiode. A transimpedance amplifier is attached on the insulator to increase the sensitivity of the photodiode. Optical fibres are seated in V-shaped grooves on the upper surface of the substrate so as to communicate with the waveguiides.

Optical transceivers are used for bidirectional communication in access network applications, such as fibre to the Xerb or fibre to the cabinet in telecommunications networks. Optical transceivers are designed to work over a temperature range of −40° C. to 85° C., making them suitable for applications in uncontrolled environments.

The efficiency of optical transceivers is adversely affected by cross-talk between the laser diode and the photocliode. It is therefore important to reduce the cross-talk between the diodes.

Three different forms of crosstalk in an optical transceiver are identified by Iwase et el in the paper Single Mocde Fiber MT-RJ SFF Transceiver Module using Optical Sub Assembly with a New Shielded Silicon Optical 1epch (Electronic Components and Technology Conference, 2000 IF) These are optical cross-talk, current cross-talk and electromagnetic cross-talk. To reduce electromagnetic cross-talk, Iwase et al place a metal plate in a trench between the laser diode and the photodiode.

Optical cross-talk occurs due to thie incidence of stray light from the laser diode on the photodiode The stray light Mnay travel from the laser diode to the photodiode either in the air (super-substrate), directly or by reflection, or through the silicon substrate (intra-substrate). To reduce super-substrate optical cross-talk it is known to adhere a ceramic block which absorbs stray light on the upper surface of the silicon substrate between the diodes or to provide the package in which the transceiver is housed wmith a plastic light absorbing lid. A problem with the former approach is that tne ceramic block is liable to become detached from the substrate and that stray light can pass through the adhesive adhering the block to the substrate. A problem with the latter approacn is tnat stray light can still propagate directly from the laser diode to the photodiode.

To reduce intra-substrate optical cross-talk it is known to provide an isolation trench in the upper surface between the laser diode and the photodiode. Moreover, GB-A-2 322 205 (Dookham Technology Limited/Day et at) makes known doping selected regions of the silicon substrate with impurity atoms to increase the absorption of stray light in those regions A problem with these approaches is that no provision is made for reducing super-substrate optical cross-talk is a general problem in optical circuit devices halving a light source, for example a light emitting diode such as a laser diode, and a circuit element whose performance is adversely affected by the incidence thereon of stray light from the light source, e.g a light sensor, another light source, a monitor, etc.

The present invention proposes to provide an optical circuit device of the type referred to above in which novel means is provided for reducing optical cross-talk between the light source and the circuit element.

### SUMMARY OF THE INVENTION

According to the present invention there is provided an optical circuit device having:

(a) a substrate with a surface and a structural discontinuity in the surface,

(b) a light source on the surface to emit light,

(c) a circuit element on the surface whose performance is adversely affected by the incidence thereon of stray light emitted by the light source, and

(d) a barrier element which is:

(i) located in the structural discontinuity,

(ii) adlapted to absorb light emitted by the light source, and

(iii) so positioned as to be able to absorb stray light emitted by the light source.

Preferably, the barrier element has a base portion in the structural discontinuity and a head portion projecting from the substrate surface. To prevent the barrier element becoming loose, it is preferable for the barrier element to be fixedly secured in the structural discontinuity, e.g. by an interference fit or through an adhesive.

The structural discontinuity may be a channel in which case the channel and the base portion may have complementary cross-sectional profiles, for example to enable an interference fit between the channel and the base portion. The channel may have a crosssectional profile having a pair of flank portions bridged by a bringing portion. The channel may have a cross-sectional profile having a pair of flank portions which converge as they extend away from the surface of the substrate, e.g. by at least one of the flank portions being tapered. The flank portions may both be tapered to form a generally V-shaped channel.

Preferably, the barrier element is formed from a composition which contains a material wflich is adapted to absorb light emitted by the light source. This light absorbing material may be carbon, for example carbon black, or a ceramic material. The light absorbing material may De incorporated in a carrier material, preferably a plastics material, for example a homopolymer, a copolymer or a blend of a thermoplastic polyester material such as poly(butylene terephthalate) or a mixture thereof. Most preferably, the barrier element is formed from a carbon loaded thermoplastic polyester.

The circuit element may be a light sensor, for example a light sensing ciode such as a ptiotodiode, or a further light source. The light source may be a light emitting diode, for example a laser diode. The circuit element may also be a monitor for monitoring the output of the light source.

If the substrate is formed from a matenal which is able to cononut the light emitted by the light source, the substrate may be provided with one or more layers of a material which is able to absorl the light emitted by the light source. Preferably, the amount of material used in the or each layer is such as to provide absorption of stray light of at least 10dB, more preferably at least 50dS. One or more layers may be provided extending in the direction of the substrate surface, for example at, or adjacent to, a further surface of the substrate. andlor a layer may be provided at, or adjacent to, at least one side of the structural discontinuity. A layer may be provded at, or adjacent, each flank poltion of the channel with the flank layers being spaced apart, for example by being separated by the bridging portion. As an example, the substrate may be formed from a semiconductor material and the or each layer is formed by doping the semiconductor material with n- or p-type impurity atoms, e.g. phosphorus and boron. The semiconductor material would ordinarily be silicon.

Preferably. the structural discontinuity and the barrier element are positioned between the light source and the circuit element. More preferably, the dimensions of the barmer element are sucf that any stray light emitted by the light source directly towards the circuit element is incident on the barrier element.

The structural discontinuity may be a first structural discontinuity with a second structural discontinuity beIng provided on a side of the light source opposite to that of the circuit element. In thlis case, it is preferred that the barrier element be a first barrier element with a second barner element being locates in the second structural discontinuity. Moreover, the or each layer of light absorbing matenal may be a first layer and a second layer is provided at, or adjacent to, at least a side of the second structural discontinuity facing the light source.

In another embodiment, the structural discontinuity is a first structural discontinuity and the tdarner element is a first barrier element, a further circuit element is located on the surface of the substrate, a second structural discontinuity is positioned between the further circuit element and the light source and a second barner element is located in the second structural discontinuity between the further circuit element and the light source. Again, the or each layer of light aosorling material may be a first layer with a second layer being provided at, or adjacent to, at least a side of the second structural discontinuity facing the light source.

The optical circ4it device of the invention may be an integrated optical chip

In an embodiment of the invention, such as hereinafter described. the structural discontinuity is a channel with a cross-sectional profile having a pair of flank portions bridged by a bridging portion, the substrate is formed from a material which is able to conduct the light emitted by the light source, and a layer of material which is able to absorb the light emitted by the light source is provided adjacent each flank portion of the channel with the flank layers being disconnected.

Embodiments of the invention will now be described with reference to the accompanying Figures of drawings.

### BRIEF DESCRIPTION OF THE DRAWINGS

FIG. 1 is a schematic, partally exploded view of a first optical circuit device in accordance with the present invention;

FIG. 2 is a view corresponding to FIG. 1 with the first device in its assembled state;

FIG. 3 is a schematic, end view of the first device; and

FIG. 4 is a schematic end view of a second opticat circuit device in accordance with the present invention.

### DETAILED DESCRIPTION OF THE EXEMPLARY EMBODIMENTS OF THE INVENTION

In the Figures of drawings like reference numerals are used to indicate like features in the different embodiments.

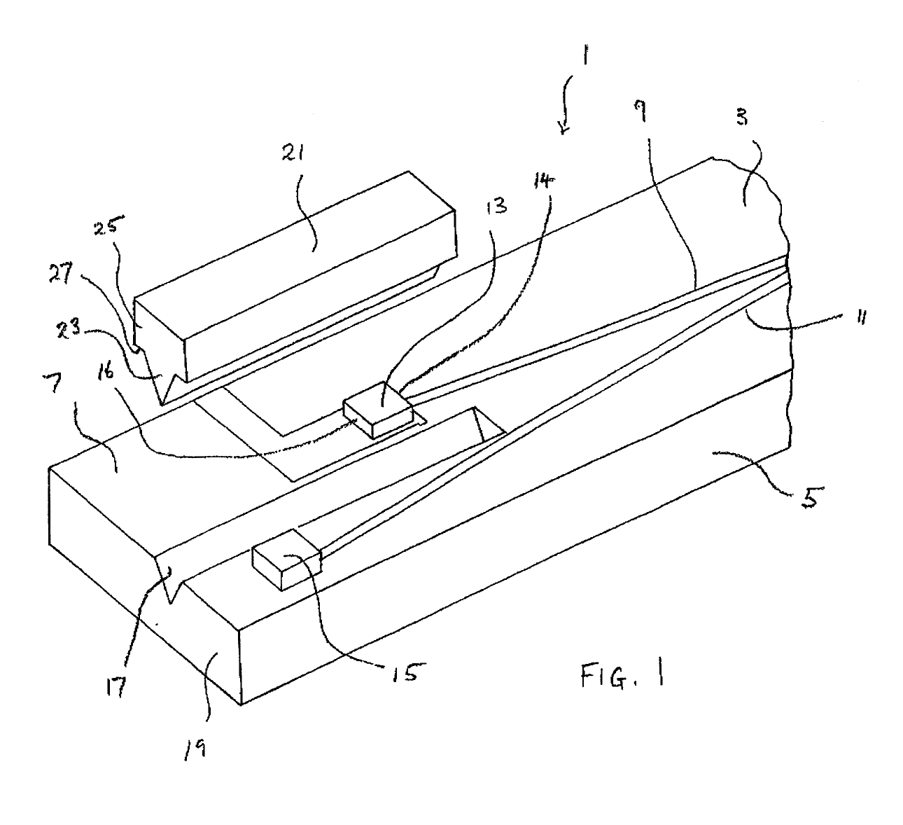

In FIGS. 1 to 3 there is shown an optical transceiver 1 in accordance with the invention having an Active Silicon Optical Circuit (ASOC) 3 comprising a silicon substrate 5 having an upper surface 7 on which is formed a pair of optical waveguides 9, 11 in a conventional manner. Located on the upper surface 7 of the substrate 5 are a laser diode 13 and a photodiode 15, each being coupled with a different optical waveguide 9, 11. The substrate upper surface 7 is also provided with an etrical trigger 12 for the laser diode 13. Although not shown, the ASOC 3 is mounted on a ceramic insulator.

In operation, the laser diode 13 emits light from both a front surface 14 and a rear surface 16. While the light emitted from the front surface 14 is directed forwardly into the associated waveguide 9, the light emitted from the rear surface 16 can give rise to optical cross-talk between the diodes 13, 15 if it Is not absored or attenuated.

As shown particutarty clearly in FIG. 1, a generally V-shaped channel 17 is provided in the upper surface 7 of the substrate 8 between the diodes 13, 15 by selective etching of the upper surface 7, e.g. with potassium hydroxide or caesium hydroxide. The channel 17 extends forwardly from a rear surface 19 of the substrate 5 to a position which is forwarci of the diodes 13, 15. It is preferable for the channel 17 to be as deep as the mechanical property requirements of the substrate 5 allow. Alternately, the depth of the channel 17 is matched to that of the V-shaped channel (not shown) provided in the upper surface 7 for seating an optical fidre to simplify the manufactwring prooess.

Although the channel 17 acts to increase the electrical resistance of the silicon substrate 5, and thereby impedes curent crosstalk between the diodes 13, 15, this is not tWe primary task of the channel 17. The channel 17 is provided to receive a block 21 of a material which is able to absorb or attenuate the light mitted by the rear surface 16 of the laser diode and any other superfluous light emitted by the laser diode 13 (hereinafter “stray light”). The wavelength of the light emitted by the laser diode 13 is 1310 nm or 1550 nm. The light absorbing material is a composition which contains a material which absorbs light of the wavelength emitted by the laser diode 13. This light absorbing material may be carbon, for example carbon black, or a ceramic material. The light absorbing material may be distributed in a carrier material, preferably a plastics material, more preferably a homopolyfner, a copolymer or a blend of a thermoplastic polyester such as poly(butylene terephthalate) or a mixture thereof. Most preferably. the block 21 is injection moulded from a composition which consists essentially of carbon loaded poly(butylene terephthalate) (Solent Semiconductor Services and AB Testhouse Ltd.).

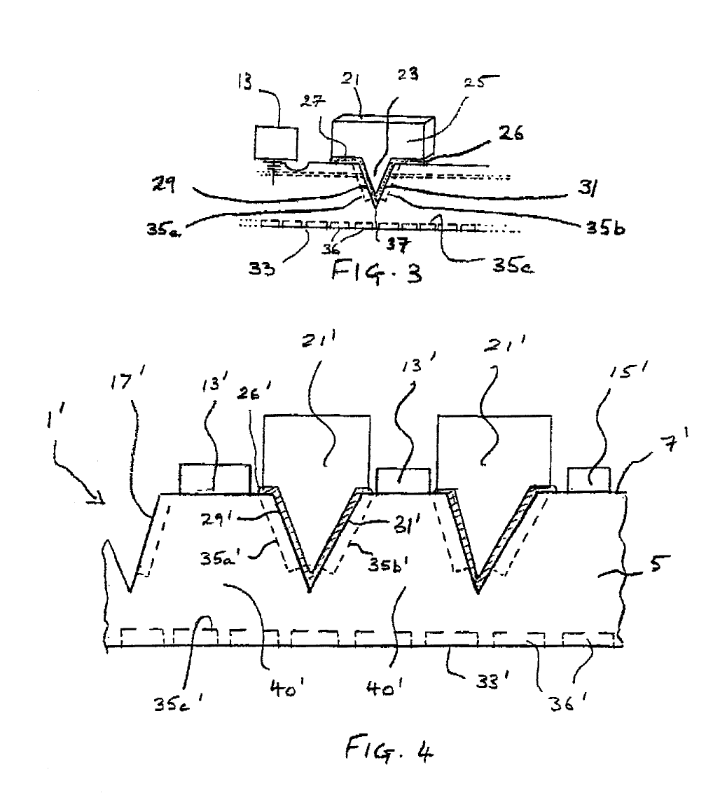

The light absorbing block 21 has a generally V-shaped lower portion 23 which fits in the channel 17 and a rectangular upper portion 25 which sits on the upper surface 7 of the substrate 5 when the lower portion 23 is fitted in the channel 17. The dimensions of the lower portion 23 of the light absoaring block 21 may be such that the block 21 is secured in the channel 17 by an interference fit. As shown in FIG. 3, an alternative is to use an adhesive 26 to secure the lower portion 23 and/or an underside 27 of the upper portion 25 of the light absorbing block 21 to the substrate 5. An acceptable adhesive would be an epoxy resin, preferably one which is not electrically conducting. In this case, the base portion 23 need not necessarily D of a complementary shape to the channel 17. For instance, the base portion may only have one tapered flank.

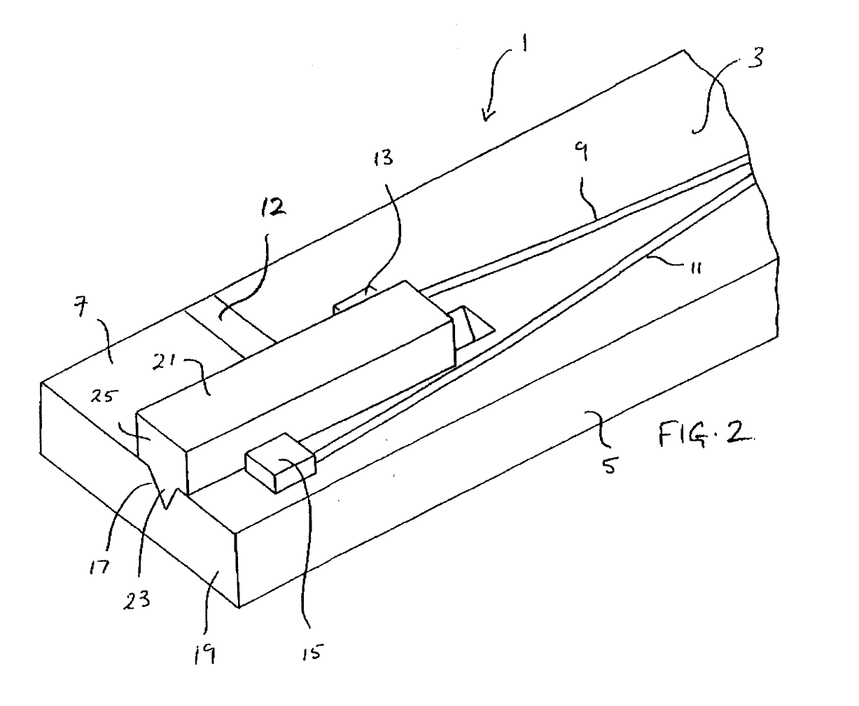

As shown in FIG. 2, the light absorbing block 21 extends forwardly in the channel 17 from the rear surface 19 of the substrate 5 to a position forwardly of the photodioce 15 and the laser diode 13, although short of the forwar end of the channel 17. Moreover, the height of the light absorbing block 21 above the substrate upper surface 7 is greater than the respective heights of the laser diode 13 and the photodicle 15 above the substrate upper surface 7.

It is preferable for the light absorbing block 21 to extend as far forward as possible. In this case, the optical transceiver 1 is to be coupled with a single optical fibre (not shown) whereby the waveguides 9, 11 converge in the forward direction for coupling with tne optical fibre. The light absorbing block 21 in this embodiment therefore extends forwardly as far as allowed by the convergent nature of the waveguides 9, 11.

The light aosorting blocK 21 acts in two ways to reduce optical cross-talk between the diodes 13, 15. Firsty. the upper portion 25 of the light absorbing block 21 acts to absorb super-substrate stray light propagating either dcircy from the laser diode 13 towards the photooiode 16 or by reflection from the internal surfaces of a chip package (not shown) in which the optical transceiver 1 is housed. Secondly, the lower portion 23 of the light absorbing blocK 21 absorts intra-substrate stray light.

Some of the advantages of using the light absorbing block 21 are:

1. It is foedly secured to the substrate S due to the lower portion 23 thereof being embedded in the substrate 5.

2. It reduces optical crosstalk resulting from both super- and intra-substrate stray light.

3. Even if an adhesive 26 is used through which stray light can be transmitted, the light absorbing blocK 21 presents a Darner to such stray light.

In addition to the light atsorbing block 21, the silicon substrate 5 of the optical transceiver 1 may be doped with light absorbing impurity atoms in accordance with G13-A-2 322 205 supra, the contents of which are hereby incorporated by reference. Referring to FIG. 3, located adjacent each flank 29, 31 of the generally V-shaped channel 17 and a lower surface 33 of the substrate 5 are layers 35a, 35b, 35c of a light absorbing impurity material. Preferably, the layers 35a, 35b, 35c are of a n- or p-type impurity atom, for example phosphorus or boron, introduced by diffusion doping in a manner known from inter alia GB-A-2 322 205.

Preferably the flank layers 35a, 35b are formed by the same type of dopant, so as not to form an unwanted diode, and are discrete so that they do not establish an electrical conducton path between the diodes 13, 15. This latter object is achieved by leaving a tip 37 of the generally V-shaped channel 17 undoped through appropriate masking. Ideally. the selective doping is such that the flank layers 35a, 35b are spaced at least 20 μm apart

The layer 35c is formed up of a series of discrete sections 36 by appropriate masking, to give a corrugated pattern, thereby avoiding the formation of a conductive channel.

The doping concentration of the layers 35a, 35b, 35c is preferably at least 10¹⁶ cm. and more preferably at least 10¹⁹ cm⁻³.

The layers 35a, 35b, 35c serve to provide additional means to reduce optical cross-talk resulting from intra-substrate stray light. An additional layer of light absorbing material (not shown) may be provided by the rear surface 19 of the substrate 5.

If desired, a second channel may be provided in the substrate upper surface 7 on the side of the laser diode 13 remote from the photodiode 15 as a means for preventing stray light being reflected back towards The photodiode 15. The electrical trigger 12 for the laser diode 13 may need to be repositioned to accommodate the second channel. A further layer of light absorbing dopant would preferably be provided adjacent the flank of the second channel facing the laser diode 13 thereby forming a chamber below the laser diode 13 bounded by three light absorbing layers. In this way, the amount of stray light able to pass through the substrate 5 to the photodiode 15 underneath the tip 37 of the channel 17 would be reduced further. A second light absorbing block could also be fixedly secured in the second channel to reduce optical cross-talk resulting from stray light reflections on the internal surfaces of the chip package.

The use of a second channel, optionally with a second light absorbing block, would be particularly useful where the optical transceiver 1 includes another circuit element on the side of the laser diode 13 remote from the photodiode 15 which needs to be protected from optical cross-talk.

The use of a second channel as described above will be understood by reference to the optical circuit device 1′ of the invention shown in FIG. 4 in which a series of laser diodes 13 and photodiodes 15′ are separated by a series of channels 17′ and light absorbing blocks 21′. Moreover, the flanks 29′, 31′ of the channels 17′ and the lower surface 33′ of the substrate 5′ are each provided with a layer 35a′, 35b′, 35c′of light absorbing material to form a series of light absorbing chambers 40′ underneath the diodes 13′, 15′. Although the layer 35c′at the lower surface 33′ is shown as being continuous, discrete layers 35c′of the sections 36′ may instead be formed at the lower surface 33′, each discrete layer 35c′of sections 36′ being underneath one of the diodes 13′, 15′.

It will be understood that the present invention is not restricted to the embodiments described with reference to the Figures of drawings but may be varied in many ways within the scope of the appended claims. For example, the present invention has application for any optical circuit device having a light source and a circuit element to be shielded from optical cross-talk.

1. An optical circuit device having:
(a) a substrate with a surface and a structural discontinuity in the surface,
(b) a light source on the surfaoe to emit light,
(c) a circuit element on the surface whose performance is adversely affected by the incidence thereon of stray light emitted by the light source, and
(d) a barier element which is:
(i) located In the structural discontinuity,
(ii) adapted to absorb light emitted by the light sourc, and
(iii) So positioned as to be able to absorb stray light emitted by the light source.

2. An optical circuit Dvice having:
(a) a substralt with a surface and a structural discontinuity in the surface,
(b) a light source on the surface to emit light,
(c) a circuit element on the surface whose performance is adversely affected by the incidence thereon of stray light emitted by the light source, and
(d) a barrier element which is:
(i) located in the structural discontinuity,
(ii) adapted to absorb light emitted by the light source, and
(iii) so positioned as to be able to absorb stray light emitted by the light source;
wherein:
(e) the structural discontinuity is a ctannel with a cross-seational profile having a pair of flank portions bridged by a brifnging portion;
(f) the substrate is formed from a material which is able to conduct the light emitted by the light source; and
(g) a layer of matenal which is able to absorb the light emitted by the light source is provided adjacent each flank portion of the channel with the flank layers being disconnected.

3. A device according to claim 1 or 2, wherein the barrier element has a base portion in the structural discontinuity and a head portion projecting from the substrate surface.

4. A device according to claim 3, wherein the structural discontinuity and the base portion have complementary cross-sectional profiles.

5. A device according to claim 1, wherein the structural discontinuity is a channel with a cross-sectional profile having a pair of flank portions bridged by a bridging portion.

6. A device according to claim 1, wherein the structural disconinuity is a channel with a cross-sectional profile having a pair of flank portions which converge as they extend away from the surface of the substrate.

7. A device according to claim 2, wherein the flank portions converge as they extend away from the surface of the substrate.

8. A device according to claim 1 or 2, wherein the barrier element is formed from a composition which contains a material which is adapted to absorb light emitted by the light source.

9. A device according to claim 8, wherein the light absorbing material is incorporated in a carrier material.

10. A device according to claim 9, wherein the carrier material is a plastics material.

11. A device according to claim 10, wherein the plastics material is selected from the group consisting of a homopolymer, a copolymer and a blend of a thermoplastic polyester material and a mixture thereof.

12. A device according to claim l1, wflerein the thermoplastic polyester material is poly(butylene terephthalate).

13. A device according to cmaim 8, wherein the light atsorbing matenal is selected from the group consisting of carbon and a ceramic material.

14. A device according to claim 1 or 2, wherein the circuit element is selected from the group consisting of a light sensor and a further light source.

15. A device according to claim 1 or 2, wherein the light source is a light emitting diode and the circuit element is selected from the group consisting of a light sensing diode. a light emitting diode and a monitor.

16. A device according to claim 1, wherein the substrate is formed from a material which is able to conduct the light emitted by the light source and wherein the suibstrate is provided with at least one layer of a matenal which is able to alisoro the light emitted by the light source.

17. A device according to claim 16, wherein at least one layer is provided extending in the same direction as the surface of the substrate.

18. A device according to claim 16, wherein a layer is provided adjacent to at least one side of the structural discontinuity.

19. A device according to claim 2, wherein the substrate is provided with at least one further layer of material which is able to absorb the light emitted by the light source.

20. A device according to claim 19, wherein at least one layer is provided extending in the same direction as the surface of the substrate.

21. A device according to claim 5, wherein a layer is provided adjacent each flank portion of the channel with the flank layers being spaced apart.

22. A device according to claim 16 wherein the substrate is formed from a semiconductor material and each layer is formed by oping the semiconductor material with impurity atoms selected from the group consisting of n- and p-type impurity atoms.

23. A device according to claim 22, wherein the semiconductor material is silicon.

24. A device according to claim 1 or 2, wherein the structural discontinuity and the barrier element are positioned between the light source and the circuit element.

25. A device accoring to claim 24. wherein the dimensions of the barrier element are such that any stray light emitted by the light source directly towards the circuit element is incident on the barrier element.

26. A device according to claim 24, wherein the structural discontinuity is a first structural discontinuity and wherein a second structural discontinuity is provided on a side of the light source opposite to that of the circuit element.

27. A device according to claim 26, wherein the barrier element is a first barrier element and wherein a second barrier element is located in the second structural disoontinuity.

28. A device according to claim 26, wherein a layer of a material able to absorb the light emitted by the light source is provided adjacent to at least a side of the second structural discontinuity facing the light source.

29. A device Eccording to claim 24, wherein the structural discontinuity is a first structural discontinuity and the barrier element is a first barrier element, wherein a further circuit elemnent is located on the surface of the substrate, wherein a second structural discontinuity is positioned between the further circuit element and the light source and wherein a second barrier element is located in the second structural discontinuity between the furtner circuit element and the light source.

30. A device according to claim 29, wherein a layer of a material able to absorb the light emitted by the light source is provided adjacent to at least a side of the second structural discontinuity facing the light source.

31. A device according to claim 1 or 2 which is an integrated optical chip.
